(19) United States
(12) Patent Application Publication
(10) Pub. No.: US 2003/0108380 A1
(43) Pub. Date: Jun. 12, 2003

(54) Pivot joint and method for molding same

(76) Inventors: Kenneth D. Schweitz, Oconomowoc, WI (US); Sean G. Redfern, Watertown, WI (US); David J. Lederer, Oconomowoc, WI (US); Trent A. Heinzel, Oconomowoc, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/012,630

(22) Filed: Dec. 7, 2001

(51) Int. Cl. F16D 1/12; F16D 3/00; F16C 11/00

(52) U.S. Cl. 403/79

(57) ABSTRACT

A pivot joint and a method for molding a pivot joint includes creating a mold to form an eyelet link and a yoke link of the pivot joint, in whatever form is desired or required. A pivot bushing and a loose part are each placed into the mold. The mold is closed and, through use of either a high pressure injection molding process or a reaction injection molding process, polyurethane plastic or resin is injected into the mold through a runner and gate system. After the joint is removed from the mold, and the loose part is removed from the joint, the gate and vent are trimmed, as are one or more sub-gates between the eyelet link and the yoke link of the pivot joint. In this fashion, a fully articulated pivot joint is created in a single molding cycle.

### FIELD OF THE INVENTION

The present invention relates generally to injection molding methods and to the products and devices that are produced by the use of such methods. More particularly, this invention relates to a method for making an articulated or pivot joint by utilizing a reaction injection molding (or “RIM”) process or a high pressure injection molding process and to the totally sealed pivot joint that is created in a single molding cycle by use of either method.

### BACKGROUND OF THE INVENTION

In the experience of these inventors, pivot joints have heretofore been manufactured using molding processes wherein a first pivot portion is molded within a first mold, the first pivot portion is removed from the first mold and placed within a second mold and a second pivot portion is molded about the first. Aside from the obvious need to manufacture such joints using a multiple step process which can be relatively time consuming, the resulting joints are generally more expensive to manufacture and can be loose in fit. And even more conventionally manufactured joints, those requiring the separate manufacture of linkages, pins, bushings and retainers and the assembly of those parts into a functional joint, may require periodic lubrication and adjustment of the various parts used.

The method of the present invention allows for the molding of such pivot joints as a single manufactured part, manufactured in a single step molding process. The method of the present invention results in relatively low manufacturing costs, zero slack or looseness in the joints, and creates joints that won't corrode and are lightweight. The resulting pivot joint is totally sealed, contains no lubricants to contaminate surroundings, and can be manufactured in accordance with the present invention in an unlimited number of configurations and in an unlimited number of devices affixed to the articulated eyelet or yoke links of the pivot joint. By way of example and not limitation, the method of the present invention could be used to mold hinges, wheels, retractable arms, holders of all types, and virtually any other object used in a folding or pivoting application. The method of the present invention could also be used to mold a plurality of interconnected joints, or a series of joints, including joints that have different axes of rotation relative to one another. It could also be used to make ratchets or cams for other applications. Moreover, the materials used in the method of the present invention are such that the end product is useful in severe environments such as nautical applications or corrosive environments.

The method of the present invention is made possible through the use of either a high pressure injection molding process or a reaction injection molding (or “RIM”) process. For purposes of the detailed description herein, the RIM process will define the preferred embodiment although the high pressure injection process could be used as well and still come within the scope of the present invention. RIM is a low pressure and low temperature plastic molding process. The low pressures and low temperatures are achieved because a chemical reaction converts two liquids into a solid polyurethane plastic. The liquids are mixed just before they are injected into a closed mold. One of the liquids, a polyol, determines the physical characteristics of the molded part. Density, impact strength, flex modulus, color and other properties are determined by the polyol used. The second liquid, an isocyanate, reacts with the polyol to form a thermoset polyurethane plastic. The chemical reaction occurs within the mold.

### SUMMARY OF THE INVENTION

The present invention has been designed and constructed to overcome some of the aforementioned shortcomings of the prior art and to fulfill the objectives of simple, one-step construction, avoidance of material costs and assembly labor, and multiple usage of the end product which end product will not corrode, will not contaminate surroundings with lubricants, will require no maintenance or adjustment, and will experience no wear and zero slack even though low tolerance components are used.

To those ends, the present invention provides a new and useful method for creating a mold to form an eyelet link and a yoke link of the pivot joint, in whatever form is desired or required. Thereafter, a pivot bushing and a loose part are each placed into the mold. The mold is closed and, through use of either a high pressure injection molding process or the reaction injection molding process briefly described above, polyurethane plastic or resin is injected into the mold through a runner and gate system. After the joint is removed from the mold, and the loose part is removed from the joint, the gate and vent are trimmed, as is the one or more sub-gates between the eyelet link and the yoke link of the pivot joint. In this fashion, a fully articulated pivot joint is created in a single molding cycle. The foregoing and other features of the method and device of the present invention will become apparent from the detailed description that follows.

### BRIEF DESCRIPTION OF THE DRAWINGS

FIG. 1 is a front, top and right side perspective view of a pivot joint molded in accordance with the present invention.

FIG. 2 is a top plan view of the pivot joint shown in FIG. 1 and showing the articulation capability of the joint in phantom view.

FIG. 3 is a front elevational and cross-sectioned view of the pivot joint shown in FIG. 1 and taken along line 3-3 of FIG. 2.

FIG. 4 is a partial front, top and right side perspective view of the pivot joint shown in FIG. 1 and illustrating the absence of the loose piece or clearance plug that is used in the molding process.

FIG. 5 is a rotated partial top, rear and left side perspective view of the pivot joint shown in FIG. 4 and illustrating an inlet gate and sub-gate that are present immediately following the molding process.

FIG. 6 is a partially sectioned top plan view of the pivot joint shown in FIG. 5.

FIG. 7 is a partial and cross-sectioned front plan view of the pivot joint shown in FIG. 5 and taken along line 7-7 of FIG. 6.

FIG. 8 is a front, left side and bottom perspective view of the bushing used in the pivot joint shown in FIG. 1.

FIG. 9 is a front, left side and bottom perspective view of the removable loose piece, or clearance plug, used in the molding of the pivot joint shown in FIG. 1.

FIG. 10 is a front elevational view of the pin, or yoke, end of the pivot joint shown in FIG. 1.

FIG. 11 is a top plan view of the eyelet end of the pivot joint shown in FIG. 1.

### DETAILED DESCRIPTION

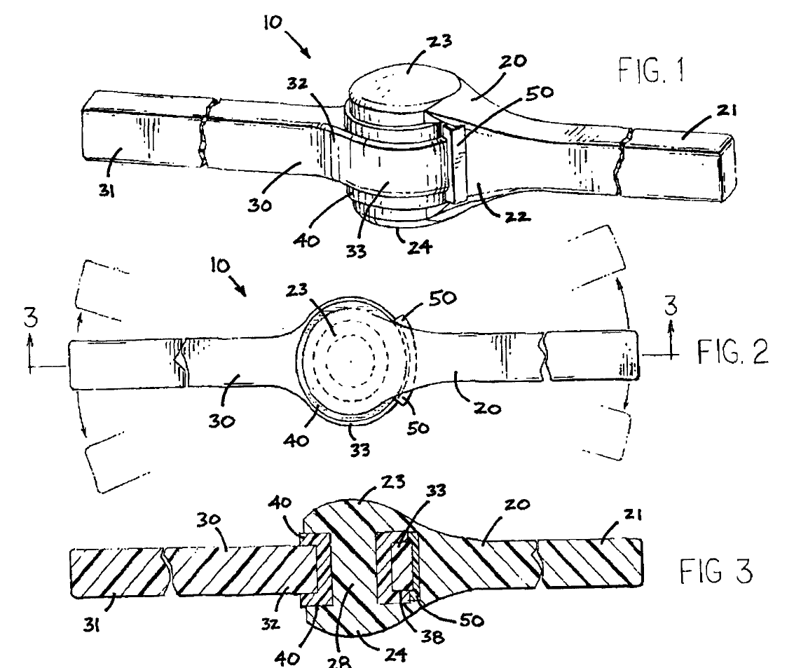

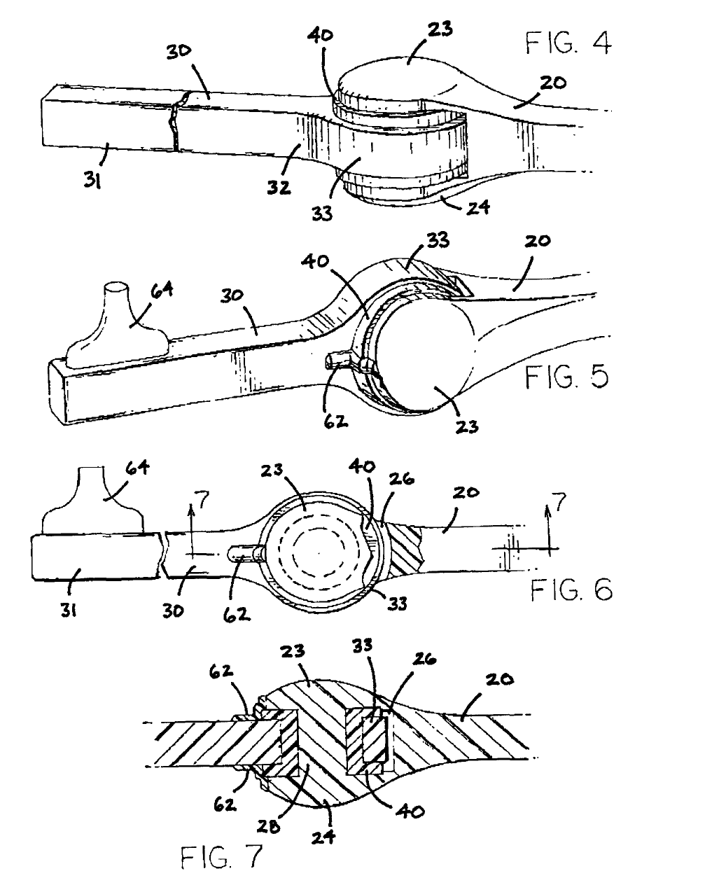

Referring now to the drawings in detail, wherein like numbers represent like elements throughout, FIG. 1 illustrates a preferred embodiment of a single pivot joint, generally identified 10, that has been molded in accordance with the method of the present invention. As previously alluded to, a number of such joints 10, interconnected or otherwise, could be created in a single process and still come within the scope of this invention. As shown, the pivot joint 10 includes a pin end, or yoke portion, 20, an eyelet end 30, and a bushing 40. A loose piece, or clearance plug, 50, is also shown but that piece is not a part of the final product. As will become apparent later in this description, this piece, or plug, 50 is really part of the mold (not shown). When used as intended, the pivot joint 10 allows the eyelet end 30 to rotate in a plane about the pin end 20, the pin end 20 and the eyelet end 30 being separated only by the bushing 40. See FIGS. 2 and 3. It is to be understood that the clearance plug 50 is not present during use of the pivot point 10, as is shown in FIG. 4, and is present only during the molding process. This feature of the method and apparatus of the present invention will become further apparent later in this detailed description.

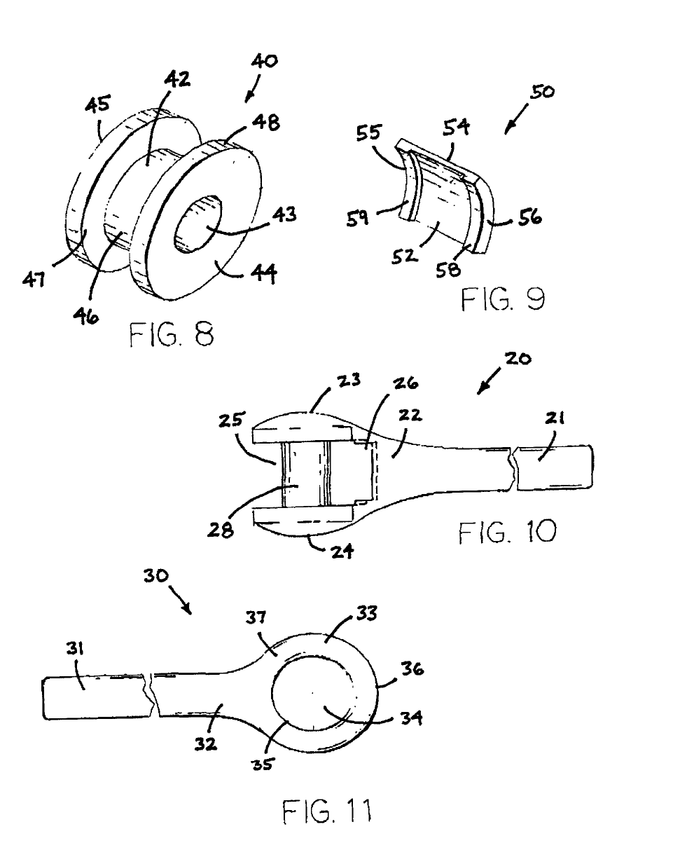

The pin end 20 includes a pin end handle or support arm 21, the pin end handle 21 including a proximal handle portion 22. See also FIG. 10. Attached to the proximal handle portion 22 of the pin end handle 21, and formed as a part of it, is an upper pivot end 23 and a lower pivot end 24. The upper pivot end 23 and the lower pivot end 24 are shown as generally circular structures that lie generally in parallel planes relative to one another. It is to be understood, however, that the upper pivot end 23 and the lower pivot end 24 could assume almost any shape and still come within the scope of this invention. The upper pivot end 23 and the lower pivot end 24 are separated by a centrally located and perpendicularly oriented central pivot portion 28. The central pivot portion 28 is substantially cylindrical in shape and is formed as an integral part of the pin end 20 and the upper pivot end 23 and lower pivot end 24 that it extends between. The pin end 20 also includes a recess 25 which is defined circumferentially about the central pivot portion 28. Immediately adjacent the proximal portion 22 of the pin end 20 is a secondary recess 26 which really forms an opening between the central pivot portion 28, the upper and lower pivot ends 23, 24 and the proximal portion 22 of the pin end 20. It is to be understood that, although the pin end 20 is shown in a particular configuration, the pin end 20 could assume any number of shapes at and outwardly from the proximal portion 22 and still come within the scope of this invention. This will become further apparent later in this detailed description.

The eyelet end 30 includes an eyelet end handle or support arm 31 and a proximal handle portion 32. See also FIG. 11. Attached to the proximal handle portion 32 and formed as an integral part of it is an eyelet end ring 33. The eyelet end ring 33 includes a ring opening 34 and a cylindrically shaped ring opening surface 35 defined within it. The eyelet end ring 33 also includes an outer ring surface 36. The eyelet end 30 further includes a ring top surface 37 and a ring bottom surface 38. The ring top and bottom surfaces 37, 38 lie in substantially parallel planes relative to each other and are generally perpendicular to the longitudinally extending axis (not shown) of the ring opening 34. It is also to be understood that, although the eyelet end 30 is show as a ring and arm type structure, that the eyelet end 30 could assume any number of shapes at and outwardly from the proximal portion 32 of the support arm 31 and still come within the scope of this invention. In fact, the eyelet end 30 could be configured to include only the ring 33 without the handle or support arm 31 altogether. In this fashion, the eyelet end 30 would function merely as a wheel or other rotational device.

The pivot joint 10 also includes a bushing 40. As shown in FIG. 8, the bushing 40 comprises a bushing core 42 and a central bushing opening 43 defined within that core 42. The bushing 40 also includes a first end surface 44 and second end surface 45. The first and second end surfaces 44, 45 lie in generally parallel planes relative to one another and are generally perpendicular to the longitudinally extending axis (not shown) of the bushing opening 43. The bushing 40 also includes a circumferentially extending first bushing shoulder 47 and a circumferentially extending second bushing shoulder 48. The first and second bushing shoulders 47, 48 are separated by a circumferential bushing recess or indent 46. In the device of the preferred embodiment, the bushing 40 is machined from an acetal material, although any number of other materials may be used. Also in the preferred embodiment, the diameter of the central bushing core opening 43 substantially matches the diameter of the central pivot portion 28 of the pin end 20. Similarly, the outer diameter of the bushing 40, less the circumferential recess 46, substantially matches the inner diameter of the ring opening 34 of the eyelet end 30. The purpose and function of these dimensions will become further apparent later in this detailed description.

Finally, the pivot joint 10 also includes, during the molding process only, a clearance plug 50. See also FIG. 9. The clearance plug 50 includes a generally arcuate structure having a back arcuate surface 54 and front arcuate surface 52. The plug 50 also includes a first end 55 and second end 56. The plug 50 further includes an upper shoulder 59 and a lower shoulder 58. The clearance plug 50 is configured in dimensions such that the plug 50 fits within the recess 25 of the pin end 20. In the preferred embodiment, the clearance plug 50 may be formed from aluminum or a variety of other mold materials. It is also possible that this clearance plug 50 could be made not as a “loose” piece, but as a moving part of the mold itself.

In application, the present invention provides a method for creating an eyelet end 30 and a yoke end 20 of a pivot joint 10, in whatever form is desired or required. Accordingly, and although it is necessary to provide a mold (not shown) for this method, the shape or size of the mold is not a limitation of the method of the present invention. The mold itself will simply assume the negative image of the pivot joint 10 that is to be molded. The mold will, however, include an inlet gate and at least one sub-gate (also not shown), but the purpose of which will become apparent. Thereafter, the pivot bushing 40 and the loose part 50 will each be placed into the mold. The mold is then closed and, through use of either the high pressure injection molding process or the reaction injection molding (RIM) process, polyurethane plastic or resin is injected into the mold through a runner and gate system. In contrast to thermoplastics, RIM plastics are composed of two liquid components that chemically react in a mold to form a plastic part. This process requires much less heat and pressure than is required by melting a thermoplastic and injecting it at a high pressure. Additionally, there are many different formulations of polyurethane plastics or resins. Strength, impact resistance, stiffness, chemical resistance and flammability resistance are just some of the important properties that may be engineered into such resins.

As shown in FIGS. 5, 6 and 7, the sub-gate 62 allows the RIM plastic to flow during the molding process from the eyelet end 30 to the pin end 20 of the pivot joint 10. In the detail of the illustrative preferred embodiment, the sub-gate 62 creates a continuum between, or passageway from, the proximal handle portion 32 of the eyelet end 30, across the shoulder 47 of the bushing 40, and to the upper pivot end 23 of the pin end 20. It should be understood that, although the sub-gate 62 is illustrated as it is in FIGS. 5, 6 and 7, the sub-gate 62 could be positioned almost anywhere between two relatively proximate portions of the eyelet end 30 and the pin end 20 and still come within the scope of the present invention. Likewise, the flow of RIM plastic could be reversed relative to the molded portions or the pivot joint 10. All that is required is that the mold continuum between the eyelet end 30 and the pin end 20 be preserved. In fact, the sub-gate 62 could be eliminated altogether if the eyelet end 30 and the pin end 20 are each separately gated and vented. Similarly, almost any number of such sub-gates 62 could be used as well. After the pivot joint 10 is formed, it is removed from the mold and the loose part 50 is removed from the joint 10. The gate 64 and vent (not shown) are trimmed, as is the sub-gate 62 between the eyelet end 30 and the pin end 20. Alternatively, other molding and tooling techniques could be used to eliminate the need for trimming each sub-gate 62. In this fashion, a fully articulated pivot joint 10 is created in a single molding cycle.

From the foregoing detailed description of the illustrative embodiment of the invention set forth herein, it will be apparent that there has been provided a new and useful method and apparatus for creating a mold to form an eyelet link and a yoke link of a pivot joint, in whatever form is desired or required. A pivot bushing and a loose part are each placed into the mold. The mold is closed and, through use of the reaction injection molding process, polyurethane plastic or resin is injected into the mold through a runner and gate system. After the joint is removed from the mold, and the loose part is removed from the joint, the gate and vent are trimmed, as is the one or more sub-gates between the eyelet link and the yoke link of the pivot joint, and a fully articulated pivot joint is created in a single molding cycle.

### PARTS LIST

10. Pivot joint

20. Pin end (yoke portion)

21. Pin end handle

22. Proximal handle end

23. Upper pivot end

24. Lower pivot end

25. Recess

26. Secondary recess

28. Central pivot portion

30. Eyelet end

31. Eyelet end handle (support arm)

32. Proximal handle portion

33. Eyelet end ring

34. Ring opening

35. Ring opening surface

36. Outer ring surface

37. Ring top surface

38 Ring bottom surface

40. Bushing

42. Bushing core

43. Central bushing opening

44. First end surface

45. Second end surface

46. Bushing recess (indent)

47. First bushing shoulder

48. Second bushing shoulder

50. Clearance plug

52. Front arcuate surface

54. Back arcuate surface

55. First end

56. Second end

58. Lower shoulder

59. Upper shoulder

62. Sub-gate

64. Gate

The principles of this invention having been fully explained in connection with the foregoing, I hereby claim as my invention:

1. A method for molding an articulated pivot joint which comprises the steps of
providing a pivot joint mold,
introducing a bushing into a portion of the mold,
injecting plastic material into the mold through use of either a high pressure injection molding process or a reaction injection molding process, and
removing the molded pivot joint from the mold.

2. The molding method of claim 1 wherein said mold providing step includes providing a mold that has a mold void for creating a pivot joint pin end therewithin.

3. The molding method of claim 2 wherein said mold providing step includes providing a mold that also has a mold void for creating a pivot joint eyelet end therewithin.

4. The molding method of claim 3 wherein said mold providing step includes providing a mold that has at least one mold void for creating at least one mold sub-gate therewithin.

5. The molding method of claim 4 wherein said sub-gate void creating step creates at least one mold continuum between said pin end void and said eyelet end void.

6. The molding method of claim 5 including, after said bushing providing step, the step of introducing a clearance plug into a portion of said mold.

7. The molding method of claim 6 including, after said joint removing step, the step of removing said clearance plug from said molded pivot joint.

8. The molding method of claim 7 including, after said pivot joint removing step, the step of trimming the at least one sub-gate from said pivot joint.

9. The molding method of claim 8 wherein a plurality of pivot joint molds are provided such that a plurality of pivot joints are molded therewithin.

10. A method for molding at least one articulated pivot joint, said at least one pivot joint including a pin end and an eyelet end, said eyelet end being rotatable about said pin end, using either a high pressure injection molding process or a reaction injection molding process which comprises the steps of
creating a mold, said mold including mold voids for said pivot joint pin end and said pivot joint eyelet end and further including at least one sub-gate for providing a mold continuum between the mold voids for said eyelet end and said pin end,
inserting a bushing into said mold, said bushing providing a mold barrier between said eyelet end and said pin end of said pivot joint,
inserting a clearance plug into said mold, said clearance plug creating a mold void at a point between a portion of said pin end and said eyelet end,
injecting mold material into said mold, and
removing at least one the molded pivot joint from said mold.

11. The molding method of claim 10 including the step of removing the clearance plug from the at least one pivot joint following removal of the at least one molded pivot joint from said mold whereby a clearance is created between a portion of the eyelet end and a portion of the pin end of said at least one pivot joint.

12. The molding method of claim 11 including, after said clearance plug removing step, the step of trimming the at least one sub-gate from said at least one pivot joint.

13. An articulated pivot joint that is created by using either a high pressure injection or a reaction injection molding process which comprises:
a pin end,
an eyelet end, said eyelet end being rotatable about a portion of said pin end,
a bushing disposed between a portion of said eyelet and a portion of said pin end, and
at least one sub-gate for providing a mold continuum between the pin end and said eyelet end, said sub-gate being removable from said pivot joint prior to use of the pivot joint.

14. The pivot joint of claim 13 wherein said pin end includes an upper pivot end and a lower pivot end, said upper pivot end and said lower pivot end comprising structures that lie in generally parallel planes relative to one another, and a central pivot portion extending perpendicularly between said upper pivot end and said lower pivot end, said central pivot portion being substantially cylindrical in shape and integrally formed with the upper pivot end and the lower pivot end.

15. The pivot joint of claim 14 wherein said eyelet end includes an eyelet end ring, said eyelet end ring including a ring opening and a substantially cylindrically shaped ring opening surface.

16. The pivot joint of claim 15 wherein said bushing includes a bushing core having an outer core surface and a central bushing opening and opening surface defined with such core, said outer core surface being in contact with the ring opening surface of said eyelet end of the pivot joint and said central bushing opening surface being in contact with the central pivot portion of said pin end of the pivot joint.

17. The pivot joint of claim 16 wherein said at least one sub-gate extends from the pin end of said pivot joint, across a portion of said bushing and to the eyelet end of said pivot joint.

18. The pivot joint of claim 17 wherein said pin end and said eyelet end are, prior to the removal of said at least one sub-gate therefrom, integrally molded as a single piece of material.

19. The pivot joint of claim 18 wherein said pivot joint is molded together with at least one other pivot joint to form a machine thereby.
